(19) United States
(12) Patent Application Publication
(10) Pub. No.: US 2025/0110642 A1
(43) Pub. Date: Apr. 3, 2025

(54) METHOD, DEVICE, AND COMPUTER PROGRAM PRODUCT FOR UPGRADING VIRTUAL STORAGE SYSTEM

(71) Applicant: DELL PRODUCTS L.P., ROUND ROCK, TX (US)

(72) Inventors: Cheng Wang, Beijing (CN); Bing Liu, Tianjin (CN); Simin Wang, Beijing (CN)

(21) Appl. No.: 18/536,683

(22) Filed: Dec. 12, 2023

(30) Foreign Application Priority Data
Sep. 28, 2023 (CN) 202311288886.X

(51) Int. Cl. G06F 3/06

(52) U.S. Cl. CPC G06F 3/0607; G06F 3/0653; G06F 3/067

(57) ABSTRACT

The present disclosure relates to a method that includes acquiring a use status of a storage space of the virtual storage system. The method further includes determining whether to upgrade the virtual storage system based on the use status. The method further includes determining a targeted instant based on the workload of the virtual storage system in response to the determination to upgrade the virtual storage system. The method further includes upgrading the virtual storage system at the targeted instant. In this way, it can be accurately determined whether to upgrade the virtual storage system based on the storage status of the virtual storage system, and when upgrade is needed, the optimum upgrade time is selected for upgrade of the system based on the workload of the virtual storage system, thereby effectively ensuring normal use of the virtual storage system.

### TECHNICAL FIELD

The present disclosure relates to the field of data storage, and more particularly, to a method, a device, and a computer program product for upgrading a virtual storage system.

### BACKGROUND

In the field of storage, multiple scattered computing resources can be combined into a logical space to create a virtual storage system for storing data. The virtual storage system can implement functions of data protection, backup, and recovery among virtual machines on the same server, across multiple servers, or in a cloud environment. Users can use the virtual storage system to store business data, enterprise data, and the like.

In general, the storage capacity of the virtual storage system can be dynamically adjusted. Users can subscribe to an appropriate storage capacity according to their use needs. With the development of business and hence increased data to be stored, the virtual storage system needs to be upgraded (such as expanding the storage capacity) in order to meet the normal business needs.

### SUMMARY OF THE INVENTION

Embodiments of the present disclosure provide a method, a device, and a computer program product for upgrading a virtual storage system. The method includes accurately determining whether to upgrade the virtual storage system based on the storage status of the virtual storage system, and when upgrade is needed, selecting the optimum upgrade time for upgrade of the system based on the workload of the virtual storage system, and effectively ensuring normal use of the virtual storage system.

In a first aspect of the embodiments of the present disclosure, a method for upgrading a virtual storage system is provided. The method includes acquiring a use status of a storage space of the virtual storage system. The method further includes determining whether to upgrade the virtual storage system based on the use status. The method further includes determining a targeted instant based on the workload of the virtual storage system in response to the determination to upgrade the virtual storage system. The method further includes upgrading the virtual storage system at the targeted instant.

In a second aspect of the embodiments of the present disclosure, an electronic device is provided. The electronic device includes one or more processors; and a storage device for storing one or more programs that, when executed by the one or more processors, cause the one or more processors to implement a method for upgrading a virtual storage system, the method including acquiring a use status of the storage space of the virtual storage system. The method further includes determining whether to upgrade the virtual storage system based on the use status. The method further includes determining a targeted instant based on the workload of the virtual storage system in response to the determination to upgrade the virtual storage system. The method further includes upgrading the virtual storage system at the targeted instant.

In a third aspect of the embodiments of the present disclosure, a computer-readable storage medium is provided, the computer-readable storage medium having a computer program stored thereon that, when executed by a processor, implements a method for upgrading a virtual storage system, and the method includes acquiring a use status of the storage space of the virtual storage system. The method further includes determining whether to upgrade the virtual storage system based on the use status. The method further includes determining a targeted instant based on the workload of the virtual storage system in response to the determination to upgrade the virtual storage system. The method further includes upgrading the virtual storage system at the targeted instant.

It should be understood that the content described in the section of Summary of the Invention is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which:

FIG. 1 illustrates a schematic diagram of an example environment in which multiple embodiments of the present disclosure can be implemented;

FIG. 2 illustrates a schematic diagram of a process for upgrading a virtual storage system according to multiple embodiments of the present disclosure;

FIG. 3 illustrates a flow chart of a method for upgrading a virtual storage system according to some embodiments of the present disclosure;

FIG. 4 illustrates a flow chart of a process for determining a targeted instant based on the historic operation condition, workload, and use status according to some embodiments of the present disclosure;

FIG. 5 illustrates a schematic diagram of a process for upgrading a virtual storage system by means of a preset cloud function according to some embodiments of the present disclosure; and

FIG. 6 illustrates a block diagram of a device that can implement multiple embodiments of the present disclosure.

### DETAILED DESCRIPTION

The embodiments of the present disclosure will be described below in further detail with reference to the accompanying drawings. Although the accompanying drawings show some embodiments of the present disclosure, it should be understood that the present disclosure may be implemented in various forms, and should not be explained as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

In the field of storage, multiple scattered computing resources can be combined into a logical space to create a virtual storage system for storing data. The virtual storage system can run on a virtual machine or in the cloud, and specifically can implement functions of data protection, backup, and recovery among virtual machines on the same server, across multiple servers, or in a cloud environment. Users can use the virtual storage system to store business data, enterprise data, and the like. As the storage capacity of the virtual storage system can be dynamically adjusted, the virtual storage system needs to be upgraded when the storage demand of a user is increased to expand the storage capacity of the virtual storage system (for example, a virtual storage system with a storage capacity of 16 TB is upgraded to a virtual storage system with a storage capacity of 32 TB). For the user, it is critical as to when upgrade is needed and how to upgrade the virtual storage system at a reasonable time node. In conventional upgrade solutions, a user (such as an administrator) calls an engineer, and it's up to the engineer to upgrade the virtual storage system.

Moreover, the user is generally not sure about the node when the virtual storage system needs to be upgraded, therefore it is typically impossible to upgrade the system at the optimum upgrade time, which affects normal use of the virtual storage system. In addition, additional communication costs and labor costs are involved.

In view of this, embodiments of the present disclosure provide a solution for upgrading a virtual storage system. In an embodiment of the present disclosure, a use status of the storage space of the virtual storage system can be acquired. It is determined whether to upgrade the virtual storage system based on the use status. As such, it can be determined directly and accurately whether the virtual storage system needs to be upgraded based on the use status of the storage space without determination by the user. Therefore, the labor costs can be saved, and the accuracy of upgrade can be improved. Further, a targeted instant is determined based on the workload of the virtual storage system in response to the determination to upgrade the virtual storage system; and the virtual storage system is upgraded at the targeted instant. As such, even if the virtual system needs to be shut down during upgrade, the impact on operation management by the enterprise user can be minimized. With the embodiments of the present disclosure, the virtual storage system can be accurately upgraded at the optimum upgrade instant.

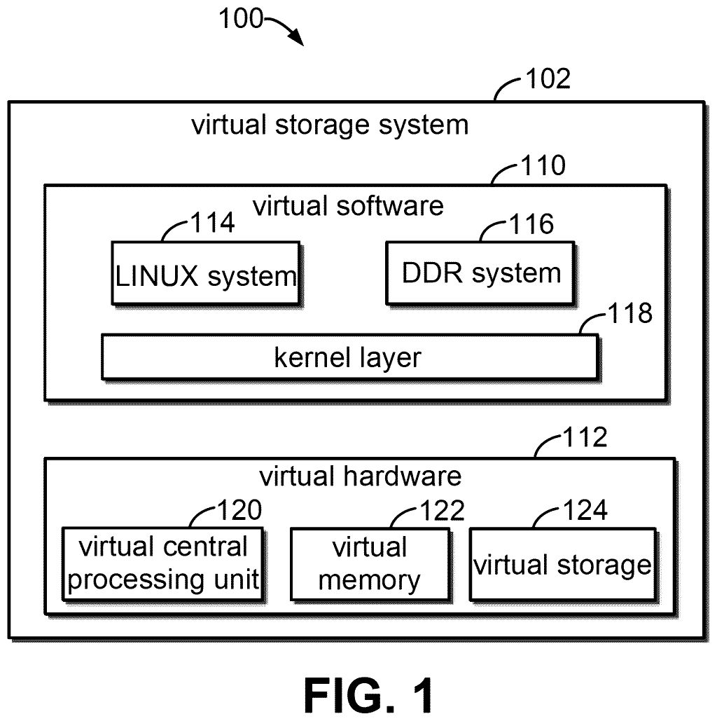

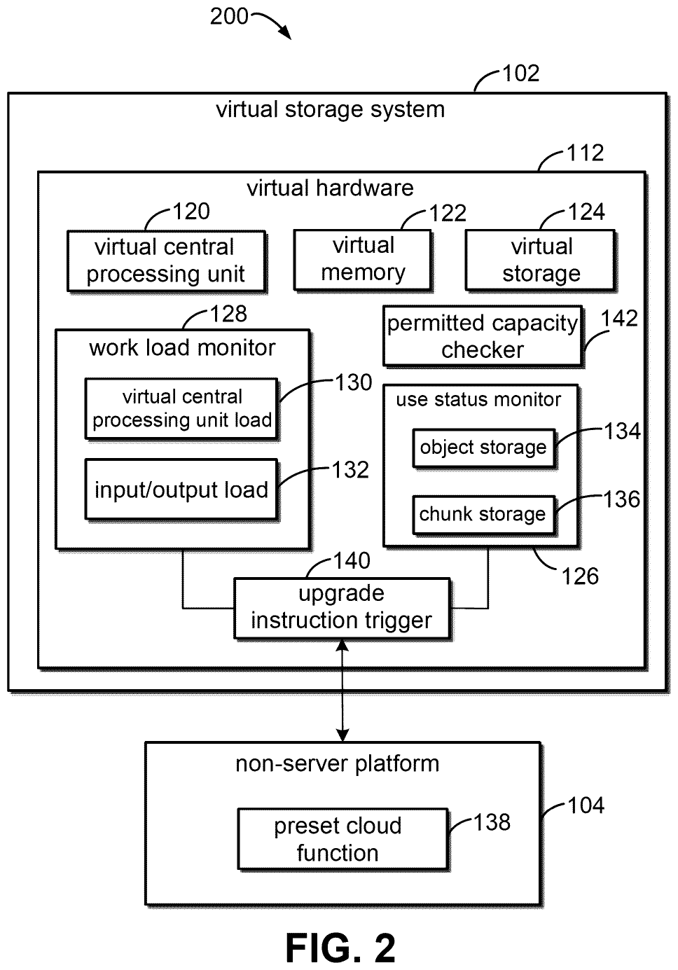

FIG. 1 illustrates a schematic diagram of an example environment 100 in which multiple embodiments of the present disclosure can be implemented. As shown in FIG. 1, the example environment 100 may include a virtual storage system 102. The virtual storage system 102 includes virtual software 110 and virtual hardware 112. The virtual software 110 includes a plurality of operating systems, such as a LINUX system 114 and a DDR system 116 (storage system software). The virtual software 110 further includes a kernel layer 118. The virtual hardware 112 includes a Virtual Central Processing Unit (Virtual CPU) 120, a virtual memory 122, and a virtual storage 124. The virtual CPU 120 can process the data (e.g., data replication, data recovery, data de-duplication, and data protection) and then store the processed data in the virtual storage 124. The upgrade for the virtual storage system 102 is the upgrade for the virtual hardware 112, such as expanding the capacity of the virtual storage 124 or increasing the size of the virtual CPU 120. The upgrade process for the virtual storage system 102 is to be described below using the example environment 200 shown in FIG. 2 as an example.

As shown in FIG. 2, the virtual storage system 102 further includes a use status monitor 126 and a workload monitor 128. The use status monitor 126 can monitor the storage space (e.g., the virtual storage 124) of the virtual storage system 102 and determine the use status of the storage space. The use status of the storage space includes the use status of an object storage 134 and the use status of a chunk storage 136. The object storage 134 can store the service data together with the metadata during data storage. As can be understood, the metadata is a type of intermediary data for describing the attribute information of the service data. For example, the metadata may be used to describe the storage location, type, style, size, and source of the service data.

As shown in FIG. 2, in the environment 200, the use status monitor 126 can be used to acquire the use status of the storage space, and consequently determine whether to upgrade the virtual storage system 102 based on the use status. For example, if the remaining capacity of the storage space is lower than a preset value, then it is determined to upgrade the virtual storage system 102. Further, after determining to upgrade the virtual storage system 102, the workload monitor 128 can be used to acquire the workload of the virtual storage system 102 and consequently determine the targeted instant based on the workload. The workload of the virtual storage system 102 includes a virtual CPU load 130 and an input/output load 132. Further, the instant when it is monitored that the workload is lower than the preset value can be determined as the targeted instant. For example, the instant when it is detected that the virtual CPU load 130 is lower than the preset value is determined as the targeted instant. Finally, the virtual storage system 102 can be upgraded at the targeted instant. For example, the virtual storage system 102 with a storage capacity of 16 TB is upgraded to a virtual storage system with a storage capacity of 32 TB.

As shown in FIG. 2, in the environment 200, before upgrading the virtual storage system 102, the permitted capacity of the virtual storage system 102 needs to be checked by using a permitted capacity checker 142 to determine whether the permitted capacity of the virtual storage system 102 satisfies the upgrade requirement. The virtual storage system 102 can be upgraded only if the upgrade requirement is satisfied. If the upgrade requirement is not satisfied, an abnormality alert message needs to be returned so as to prompt the user to add a permit to apply for the system resource required for upgrade of the virtual storage system 102.

In some embodiments, to save the capital costs and operation costs needed by upgrade of the virtual storage system, the virtual storage system can be upgraded on a non-server platform. For example, the virtual storage system is upgraded by using a preset cloud function deployed on the non- server platform. For example, as shown in FIG. 2, the environment 200 further includes a non-server platform 104 including a preset cloud function 138. The non-server platform 104 and the virtual storage system 102 run in a computing cloud, and the computing cloud provides the computation resource needed by the preset cloud function 138 and the computation resource needed by the virtual storage system 102. The virtual storage system 102 further includes an upgrade instruction trigger 140. After determining that the virtual storage system 102 needs to be upgraded and determining the targeted instant for upgrade, the upgrade instruction trigger 140 is enabled to generate an upgrade instruction containing the targeted instant. The non-server platform 104 communicates with the virtual storage system 102 to receive the upgrade instruction generated by the virtual storage system 102. After receiving the upgrade instruction, the preset cloud function 138 is triggered to upgrade the virtual storage system 102 by using the preset cloud function 138.

In this way, it can be accurately determined whether to upgrade the virtual storage system based on the storage status of the virtual storage system, and when upgrade is needed, the optimum upgrade time can be selected for upgrade of the system based on the workload of the virtual storage system, thereby ensuring normal use of the virtual storage system.

It should be understood that description of the architecture and function in the example environment 100 is made for illustrative purposes only and does not imply any limitation to the scope of the present disclosure. The embodiments of the present disclosure may also be applied to other environments with different architectures and/or functions.

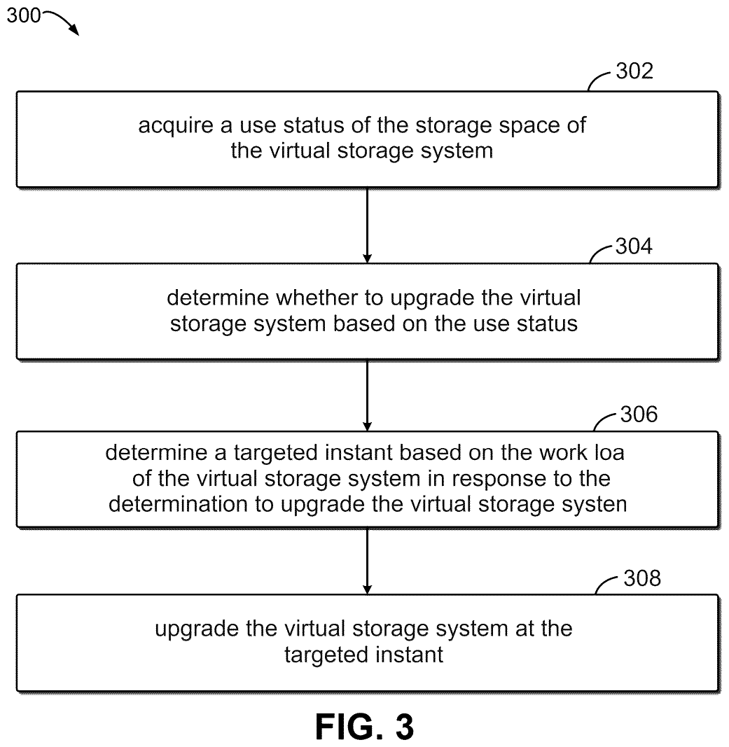

A process according to an embodiment of the present disclosure will be described in detail below with reference to FIG. 3 to FIG. 6. Specific data mentioned in the following description for the convenience of understanding is exemplary and is not intended to limit the protection scope of the present disclosure. It should be understood that embodiments described below may also include additional actions not shown and/or may omit actions shown, and the scope of the present disclosure is not limited in this regard.

FIG. 3 illustrates a flow chart of a method 300 for upgrading a virtual storage system according to some embodiments of the present disclosure. The virtual storage system 102 is the subject for executing the method 300. In the block 302, the method 300 acquires a use status of the storage space of the virtual storage system. The use status of the storage space refers to used capacity, remaining capacity, or used capacity percentage of the storage space. The used capacity percentage refers to the ratio of the storage capacity that has been used to the storage capacity of the storage space. For example, the use status may be the used capacity of each virtual storage 124. The use status of the storage space can be monitored in real time or monitored regularly by a use status monitor (e.g., the use status monitor 126 in FIG. 2). Regular monitoring refers to monitoring the use status of the storage space at a preset time interval. In the case of regular monitoring, the use status of the storage space at the next instant can be calculated according to the data read speed, bandwidth utilization, and the like, thereby preventing the case where the time interval for regular monitoring is so long that normal upgrade of the virtual storage system cannot be performed subsequently, which affects the normal use.

In some embodiments, the storage space includes various types of storages, such as object storage and chunk storage. The use status of the storage space may be the use status of object storage or the use status of chunk storage. For example, the use status of the storage space may include the remaining capacity of object storage and the remaining capacity of chunk storage. Alternatively, the use status of the storage space may also be the remaining capacity of file storage.

In the block 304, the method 300 determines whether to upgrade the virtual storage system based on the use status. For example, if the use status reaches a first set status, it is determined to upgrade the virtual storage system; and if the use status has not reached the first set status, it is determined not to upgrade the virtual storage system. The first set status may be a first preset remaining capacity threshold, a first preset used capacity threshold, or a first preset remaining capacity percentage threshold.

In some embodiments, the storage capacity used for storing various data is not necessarily the same for the chunk storage and the object storage. For example, the used capacity for the chunk storage is larger than that for the object storage. It can be determined herein whether to upgrade the virtual storage system based on the use status of the chunk storage. The method 300 may determine whether to upgrade the virtual storage system based on the comparison between the use status of the chunk storage and the set status the chunk storage. For example, if the remaining capacity of the chunk storage is lower than the preset remaining capacity threshold of the chunk storage (or the remaining capacity is zero), then the virtual storage system is to be upgraded. The preset remaining capacity threshold of the chunk storage may be determined by the size of the virtual storage.

In some embodiments, it can also be determined whether to upgrade the virtual storage system based on the use status of the object storage. The method 300 may determine whether to upgrade the virtual storage system based on the comparison between the use status of the object storage and the set status the object storage. For example, if the remaining capacity of the object storage is lower than the preset remaining capacity threshold of the object storage (or the remaining capacity is zero), then the virtual storage system is to be upgraded. Alternatively, if the used capacity of the object storage reaches the capacity upper limit of the virtual storage system, then the virtual storage system is to be upgraded.

Continuing to refer to FIG. 3, in the block 306, the method 300 determines a targeted instant based on the workload of the virtual storage system in response to the determination to upgrade the virtual storage system. Upgrade of the virtual storage system may be made in a number of manners, some of which require shutting down the virtual storage system before the upgrade. Therefore, the targeted instant for upgrade needs to be determined based on the workload of the virtual storage system in order to mitigate the impact on the operation management of the enterprise user or other users.

In some embodiments, the workload of the virtual storage system can be monitored, and the monitored instant when the workload is low is determined as the targeted instant. The workload is the amount of work of the virtual storage system and includes a virtual CPU load, an input/output (IN/OUT) load, a memory load, and the like. For example, the virtual CPU load refers to the complexity of a task being processed by the virtual CPU in a period of time. It can reflect the current operation condition of the system and is a metric of the quantity of burden that can be borne by the system.

In some embodiments, the instant when the workload is lower than a first preset workload threshold is determined as the targeted instant. For example, the instant when the virtual CPU load is lower than a first preset workload threshold can be determined as the targeted instant. Alternatively, the instant when the memory load is lower than a first preset workload threshold is determined as the targeted instant. The first preset workload threshold can be determined according to the use demand of the user and the application environment. It can be understood that, in order to prevent the case where the remaining capacity of the storage space is lower than the capacity upper limit (e.g., the remaining capacity is zero), the first preset workload threshold should not be set too low (e.g., the first preset workload is zero).

In some embodiments, in order to make the determined targeted instant more accurate and to save upgrade cost for the user, the use status can be combined with the workload, and the targeted instant is determined based on the workload and the use status. Specifically, the targeted instant can be directly determined based on the use status and workload that are monitored in real time. For example, the targeted instant can be determined in response to the workload being lower than a second preset workload threshold and the use status reaching a second set status. The second set status can be set lower than the first set status described above. For example, the second preset remaining capacity threshold is lower than the first preset remaining capacity threshold. As such, the virtual storage system can be upgraded in the case of low workload and maximized used capacity. It can be understood that, in the case where the use status has reached the second set status while the workload is greater than the second preset workload threshold, the virtual storage system can also be upgraded if the difference between the workload and the second preset workload threshold is in a permitted range.

In this way, on the one hand, the problem can be avoided that normal use of the virtual storage system by the user is affected because upgrade of the system is delayed for a long time due to the high workload. On the other hand, user costs can be saved, thereby maximizing user benefits.

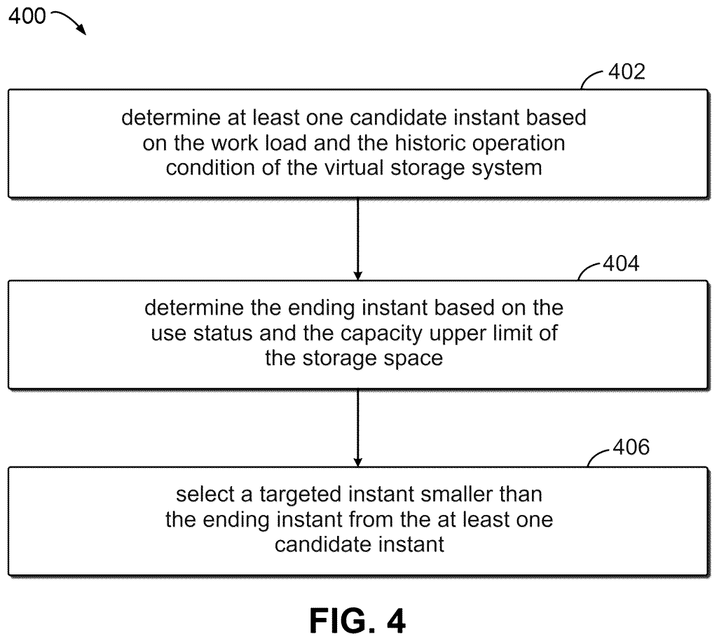

In some embodiments, in order to further improve the accuracy and reasonableness of the targeted instant, the historic operation condition, the workload, and the use status of the virtual storage system can be combined to determine the targeted instant. An example implementation of determining the targeted instant based on the historic operation condition, the workload, and the use status is described below with reference to FIG. 4.

FIG. 4 illustrates a schematic diagram of a process for determining a targeted instant based on the historic operation condition, workload, and use status according to some embodiments of the present disclosure. In the block 402, linear regression can be performed on the workload based on the historic operation condition of the virtual storage system to determine multiple candidate instants when the workload is low (or even the workload is zero). Alternatively, multiple candidate instants can be directly determined based on the historic operation condition. For example, a bank is taken as an example. The bank is on service from Monday to Friday and closes on Saturday and Sunday. The workload of the virtual storage system used by the bank is low on Saturday and Sunday. Therefore, the candidate instant may be a certain instant on Saturday or a certain instant on Sunday. The historic operation condition may be the workload of the virtual storage system in a historic time period. Specifically, it may be the workload of the virtual storage system at various historic instants or the variation trend of the workload in a historic time period. For example, the historic operation condition may be the variation of the workload of the virtual storage system used by the bank over the previous week.

In some embodiments, multiple historic instants when the historic workload is lower than the third preset workload threshold can be determined based on the variation trend of the historic workload. Thereafter, multiple candidate instants can be determined based on the historic instants.

In the block 404, the ending instant for upgrade of the virtual storage system can be calculated by using the use status (e.g., the used capacity) of the storage space. The ending instant refers to the latest instant for upgrade of the virtual storage system before which the virtual storage system needs to be upgraded. Specifically, the permitted time length over which the current used capacity of the storage space reaches the capacity upper limit can be calculated based on the remaining data storage capacity of the virtual storage system and the data storage speed. The ending instant is determined based on the permitted time length and current instant. Alternatively, the ending instant can be determined based on a result of comparison between the bandwidth utilization of the virtual storage system and the bandwidth utilization required by the user. Still further, in the block 406, multiple candidate instants can be screened based on the ending instant to determine the targeted instant. If a candidate instant is greater than the ending instant, this candidate instant is filtered out. If a candidate instant is smaller than the ending instant, this candidate instant is determined as the targeted instant.

In this manner, an optimum upgrade instant satisfying requirements in all the aspects can be determined. For example, if upgrade is done at this targeted instant, not only is the storage space utilization maximized, but also the workload of the virtual storage system is low, so that shutdown of the virtual storage system will not have substantial impact on the user.

In some embodiments, the overall condition of the workload may also be determined from the data backup time information of the virtual storage system. For example, the more the data backups, the higher the workload. Thereafter, the instant when the workload is low (e.g., the workload is at minimum) is determined as the targeted instant.

Referring back to FIG. 3, in the block 308, the method 300 upgrades the virtual storage system at the targeted instant. There are many ways to upgrade the virtual storage system. For example, a virtual storage may be added in the virtual storage system, and the number and capacity size of the added virtual storages may be determined based on the size of the service data to be stored or other data. For example, a virtual storage with a capacity of 1 TB may be added in the virtual storage system.

Moreover, the capacity of the virtual storage system may be expanded. For example, multiple virtual storage systems may be deployed in a public cloud, and the capacities of the multiple virtual storage systems share the resource pool of the public cloud. Therefore, application may be made to the public cloud for cloud resource so as to expand the capacity of the virtual storage system. For example, the capacity of the existing virtual storage of the virtual storage system may be expanded. Alternatively, as different types (sizes) of virtual storage systems are configured with different capacity upper limits of the storage space, e.g., 16 TB, 32 TB, or 64 TB, a virtual storage system may be reconfigured by switching the type of the virtual storage system, so as to upgrade the virtual storage system.

In some embodiments, the configuration of the virtual storage system can decide the size of the usable capacity of the virtual storage system, and the used capacity permitted by the virtual storage system has an upper limit. Therefore, before upgrading the virtual storage system, it is necessary to determine whether the configuration of the virtual storage system satisfies the upgrade requirement (e.g., the storage capacity required for upgrade of the virtual storage system). Specifically, the configuration information may be acquired by using a permitted capacity checker (such as the permitted capacity checker 142 shown in FIG. 1). The configuration information includes the size of a virtual CPU (such as the virtual CPU 120 shown in FIG. 1), the size of a virtual memory (such as the virtual memory 122 shown in FIG. 1), and the size of a virtual storage (such as the virtual storage 124 shown in FIG. 1) of the virtual storage system. If the configuration information satisfies the upgrade requirement, then the virtual storage system is upgraded. For example, if the size of the virtual storage is greater than the storage capacity required for upgrade of the virtual storage system, then the virtual storage system is upgraded.

In some embodiments, if the configuration information does not satisfy the upgrade requirement, an abnormality alert message needs to be returned so as to prompt the user to acquire a permit from the virtual storage system to increase the permitted capacity of the virtual storage system. The permit takes two forms, one is a node locking permit (no service mode), and the other is a service mode permit. After acquiring the permit, application may be made to the cloud server or the virtual machine or the like for system resources required for upgrade of the virtual storage system, and the virtual storage system is reconfigured. For example, a 4G virtual CPU of the virtual storage system is reconfigured as an 8G virtual CPU, and a 16TB virtual storage of the virtual system is reconfigured as a 32 TB virtual storage.

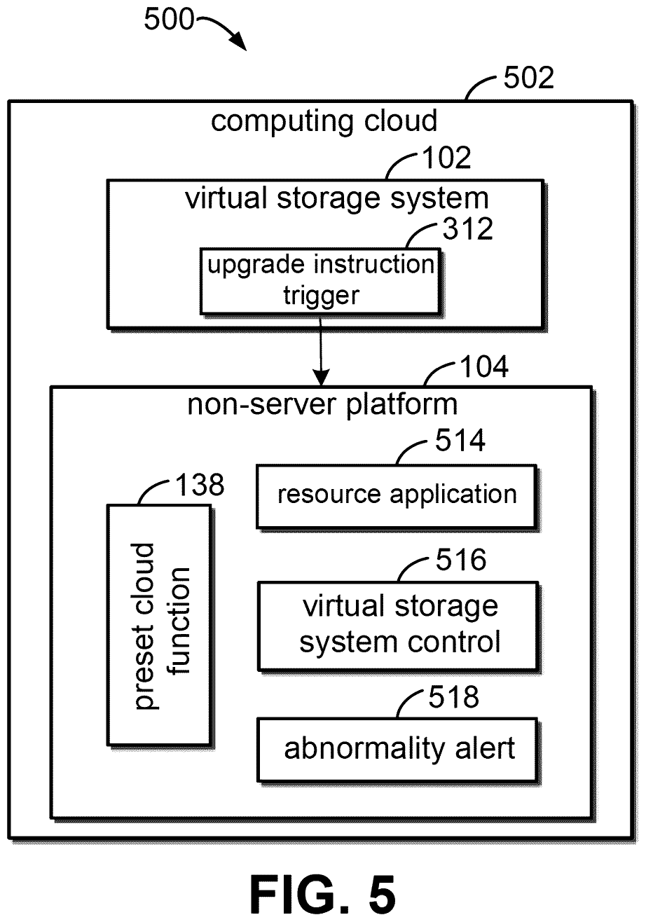

In some embodiments, some upgrade modes necessitate shutdown of the virtual storage system and restart of the virtual storage system after upgrade. In order to reduce the cost, a preset cloud function may be used to start/shut down the virtual storage system automatically and expand the capacity of the virtual storage system. The preset cloud function is a function that is deployed in advance to run in the cloud (the server side). A preset cloud function may consist of multiple files and occupy a certain amount of computation resource. Each preset cloud function deals with one upgrade task, and individual cloud functions are independent from each other. As there are multiple upgrade modes, the multiple preset cloud functions may be used to perform different upgrade modes respectively. An example implementation of upgrading the virtual storage system by the preset cloud function is described below with reference to FIG. 5.

FIG. 5 illustrates a schematic diagram of a process for upgrading a virtual storage system by means of a preset cloud function according to some embodiments of the present disclosure. As shown in FIG. 5, an environment 500 includes a computing cloud 502 in which the virtual storage system 102 and a non-server platform 504 run. The computing cloud 502 includes a public cloud, which generally refers to a usable cloud provided to users by a third party provider. A preset cloud function 138 is deployed on the non-server platform 104, and there may be multiple preset cloud functions 138. The computing cloud 502 is a computation model that separates a resource from physical hardware and provides it to a user as a service. The computing cloud 502 provides configurable computation resources, such as a server, a storage, a network, or an application. The user can use these computation resources according to his own demand on a pay-by-volume basis.

In some embodiments, the virtual storage system 102 can trigger the upgrade instruction based on the use status of the storage space. The upgrade instruction can indicate the system resources required for upgrade of the virtual storage system 102, the targeted instant for upgrade, and the like. Further, the preset cloud function 138 can run on the non-server platform 104 to upgrade the virtual storage system 102. As shown in FIG. 5, in the block 514, the preset cloud function 138 can send a system resource application to the computing cloud 502 to apply for the system resource required for upgrade of the virtual storage system 102. In the block 516, in the case where a system resource is received, the virtual storage system 102 can be shut down by using the preset cloud function 138. Then, the virtual storage system 102 is upgraded based on the system resource by using the preset cloud function 138. After completion of the upgrade, the virtual storage system 102 can be restarted. Continuing to refer to FIG. 5, in the block 518, after acquiring an upgrade log by using the preset cloud function 138, an abnormality alert message is returned in the case of upgrade failure. In such an upgrade mode, based on the advantages of the preset cloud function itself (e.g., no additional cost when not running, and no need for deployment of an additional application to assist with the upgrade), the upgrade cost can be saved, and the upgrade efficiency can be improved.

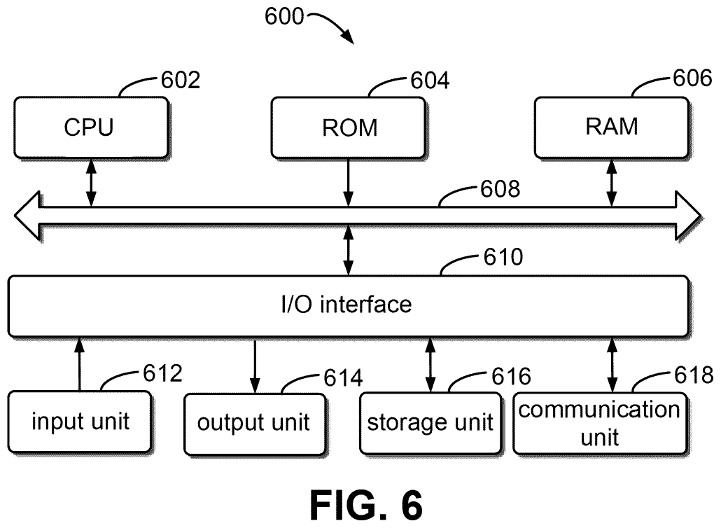

FIG. 6 shows a schematic block diagram of an example device 600 that may be used to implement the embodiments of the present disclosure. As shown in the figure, the device 600 includes a computing unit 601 that can perform various appropriate actions and processing according to computer program instructions stored in a read-only memory (ROM) 602 or computer program instructions loaded from a storage unit 608 to a random access memory (RAM) 603. Various programs and data required for the operation of the device 600 may also be stored in the RAM 603. The computing unit 601, ROM 602, and RAM 603 are connected to each other via a bus 604. An input/output (I/O) interface 605 is also connected to the bus 604.

A plurality of components in the device 600 are connected to the I/O interface 605 and include: an input unit 606, such as a keyboard, a mouse, and the like; an output unit 607, such as various types of displays, speakers, and the like; a storage unit 608, such as a magnetic disk, an optical disc, and the like; and a communication unit 609, such as a network card, a modem, a wireless communication transceiver, and the like. The communication unit 609 allows the device 600 to exchange information/data with other devices via a computer network, such as the Internet, and/or various telecommunication networks.

The computing unit 601 may be various general-purpose and/or special-purpose processing components with processing and computing power. Some examples of the computing unit 601 include, but are not limited to, a central processing unit (CPU), a graphics processing unit (GPU), various specialized artificial intelligence (AI) computing chips, various computing units for running machine learning model algorithms, a digital signal processor (DSP), and any appropriate processor, controller, microcontroller, and the like. The computing unit 601 performs various methods and processes described above, such as the method 300. For example, in some embodiments, the method 300 may be implemented as a computer software program that is tangibly included in a machine- readable medium such as the storage unit 608. In some embodiments, part of or all the computer program may be loaded and/or installed onto the device 600 via the ROM 602 and/or the communication unit 609. When the computer program is loaded to the RAM 603 and executed by the computing unit 601, one or more steps of the method 300 described above may be performed. Alternatively, in other embodiments, the computing unit 601 may be configured to perform the method 300 in any other suitable manners (such as by means of firmware).

The functions described hereinabove may be performed at least in part by one or more hardware logic components. For example, without limitation, exemplary types of available hardware logic components include: a Field Programmable Gate Array (FPGA), an Application Specific Integrated Circuit (ASIC), an Application Specific Standard Product (ASSP), a System on Chip (SOC), a Load Programmable Logic Device (CPLD), and the like.

Program code for implementing the method of the present disclosure may be written by using one programming language or any combination of a plurality of programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combinations thereof. Additionally, although operations are depicted in a particular order, this should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for upgrading a virtual storage system, comprising:
acquiring a use status of a storage space of the virtual storage system;
determining whether to upgrade the virtual storage system based on the use status;
determining a targeted instant based on a workload of the virtual storage system in response to the determination to upgrade the virtual storage system; and
upgrading the virtual storage system at the targeted instant.

2. The method according to claim 1, wherein determining the targeted instant comprises:
determining an instant when the workload is lower than a first preset workload threshold as the targeted instant.

3. The method according to claim 1, wherein determining the targeted instant comprises:
determining the targeted instant based on the workload and the use status.

4. The method according to claim 3, wherein determining the targeted instant comprises:
determining the targeted instant in response to the workload being lower than a second preset workload threshold and the use status reaching a second set status.

5. The method according to claim 3, wherein determining the targeted instant comprises:
determining at least one candidate instant based on the workload and a historic operation condition of the virtual storage system;
determining an ending instant based on the use status and a capacity upper limit of the storage space; and
selecting a targeted instant smaller than the ending instant from the at least one candidate instant.

6. The method according to claim 5, wherein the historic operation condition comprises a historic workload corresponding to each historic instant during historic operation of the virtual storage system, and determining at least one candidate instant comprises:
determining at least one targeted historic instant when the historic workload is lower than a third preset workload threshold; and
determining the at least one candidate instant based on the historic workload corresponding respectively to the at least one targeted historic instant and the workload.

7. The method according to claim 5, wherein the use status comprises the a used capacity of the storage space, and determining the ending instant comprises:
acquiring the remaining storage data and storage speed of the virtual storage system; and
determining the ending instant based on the remaining storage data, the storage speed, the used capacity, and the capacity upper limit.

8. The method according to claim 1, wherein the use status comprises the use status of an object storage and determining whether to upgrade the virtual storage system comprises:
determining to upgrade the virtual storage system in response to the use status of the object storage reaching a set status of the object storage.

9. The method according to claim 1, wherein the use status comprises the use status of a chunk storage, and determining whether to upgrade the virtual storage system comprises:
determining to upgrade the virtual storage system in response to the use status of the chunk storage reaching a set status of the chunk storage.

10. The method according to claim 1, wherein upgrading the virtual storage system comprises:
acquiring configuration information of the virtual storage system;
determining whether the configuration information satisfies an upgrade requirement; and
upgrading the virtual storage system in response to the configuration information satisfying the upgrade requirement.

11. The method according to claim 10, further comprising:
providing a prompt message to increase the-a permitted capacity of the virtual storage system in response to the configuration information not satisfying the upgrade requirement.

12. The method according to claim 1, wherein upgrading the virtual storage system comprises at least one of:
adding a virtual storage;
expanding a capacity of the virtual storage system; and
reconfiguring the virtual storage system.

13. The method according to claim 1, wherein upgrading the virtual storage system comprises:
upgrading the virtual storage system by using a preset cloud function.

14. An electronic device, comprising:
at least one processor; and
a memory coupled to the at least one processor and having instructions stored thereon that, when executed by the at least one processor, cause the electronic device to perform actions comprising:
acquiring a use status of a storage space of the a virtual storage system;
determining whether to upgrade the virtual storage system based on the use status;
determining a targeted instant based on the a workload of the virtual storage system in response to the determination to upgrade the virtual storage system; and
upgrading the virtual storage system at the targeted instant.

15. The device according to claim 14, wherein determining the targeted instant comprises:
determining an instant when the workload is lower than a first preset workload threshold as the targeted instant.

16. The device according to claim 14, wherein determining the targeted instant comprises:
determining the targeted instant based on the workload and the use status.

17. The device according to claim 16, wherein determining the targeted instant comprises:
determining the targeted instant in response to the workload being lower than a second preset workload threshold and the use status reaching a second set status.

18. The device according to claim 16, wherein determining the targeted instant comprises:
determining at least one candidate instant based on the workload and a historic operation condition of the virtual storage system;
determining an ending instant based on the use status and a capacity upper limit of the storage space; and
selecting a targeted instant smaller than the ending instant from the at least one candidate instant.

19. The device according to claim 18, wherein the historic operation condition comprises a historic workload corresponding to each historic instant during historic operation of the virtual storage system, and determining at least one candidate instant comprises:
determining at least one targeted historic instant when the historic workload is lower than a third preset workload threshold; and
determining the at least one candidate instant based on the historic workload corresponding respectively to the at least one targeted historic instant and the workload.

20. A computer program product tangibly stored on a non-transitory computer-readable medium and comprising machine-executable instructions that, when executed, cause a machine to perform actions comprising:
acquiring a use status of a storage space of a virtual storage system;
determining whether to upgrade the virtual storage system based on the use status;
determining a targeted instant based on the a workload of the virtual storage system in response to the determination to upgrade the virtual storage system; and
upgrading the virtual storage system at the targeted instant.
